(19) United States
(12) Patent Application Publication
(10) Pub. No.: US 2026/0057287 A1
(43) Pub. Date: Feb. 26, 2026

(54) AUTOMATIC MODEL CARD GENERATION FOR MACHINE LEARNING MODELS

(71) Applicant: NVIDIA Corporation, Santa Clara, CA (US)

(72) Inventors: Rajat Keshri, Belmont, CA (US); Arun George Zachariah, San Jose, CA (US); Michael Boone, Los Gatos, CA (US); Kimberly Le Truong, Santa Clara, CA (US)

(21) Appl. No.: 18/811,020

(22) Filed: Aug. 21, 2024

(51) Int. Cl. G06N 20/00

(52) U.S. Cl. CPC G06N 20/00

(57) ABSTRACT

In various examples, automatic generation of model cards for machine learning models is described herein. Systems and methods are disclosed that use one or more language models, which process input data representing information associated with a model (e.g., a machine learning model, an AI model, a neural network, etc.), to automatically generate a model card to associate with the model. As described herein, the information associated with the model may include at least a portion of source code used to generate the model, one or more documents that describe the model, one or more previously generated model cards, and/or any other information associated with the model. Additionally, in some examples, additional data may be input into the language model(s) to generate the model card, such as data representing questions for retrieving relevant information and/or data representing reference information associated with one or more other models.

### BACKGROUND

Models (e.g., machine learning models, neural networks, etc.) may be used in a wide variety of applications, including, but not limited to, healthcare, finance, transportation, manufacturing, and/or entertainment. For instance, in healthcare-related contexts, AI-powered systems may assist in diagnosing diseases, analyzing medical images, and/or personalizing treatment plans. In contrast, models used for transportation-related contexts may enable machines (e.g., semi-autonomous and/or fully autonomous vehicles) to perceive their surroundings and navigate safely. Consequently, different models may be adapted for different uses and/or possess different strengths and weaknesses, even when comparing different models within the same context (e.g., transportation).

To help understand the capabilities, limitations, and/or differences between models, end users may evaluate model cards associated with models. For instance, a model card may contain various information about a particular model, such as the model's development process, training data, performance metrics, potential biases, limitations, intended use cases, and/or out-of-scope applications, which may allow the end users to make informed decisions about the model's deployment and/or use. Additionally, this model card may also help support compliance with regulatory standards and/or industry best practices. As such, organizations may use model cards to demonstrate adherence to various requirements, such as legal requirements, corporate compliance requirements, and/or ethical requirements, which may help ensure AI systems are developed and/or deployed in a manner that aligns with societal values and norms.

As such, conventional systems may use various tools and/or platforms in an attempt to generate model cards for models, such as Model Cards Toolkit, Python Toolkit, Papers with Code, HuggingFace Model Card Generator, and others. However, with each of these tools and/or platforms, users need to manually search through information describing the models in order to input the relevant portions of the information into the model cards. Additionally, when these models are updated—such as with further training—these conventional systems need the users to update the model cards in order to keep the information accurate. As such, generating and/or updating model cards may require large amounts of human resources and/or time. Additionally, generating and/or updating model cards may be prone to errors, such as errors from users inputting inaccurate information and/or errors from model cards not being updated to reflect the current versions of the models.

### SUMMARY

Embodiments of the present disclosure relate to automatic model card generation for machine learning models. Systems and methods are disclosed that use one or more language models, which process input data representing information associated with a model (e.g., a machine learning model, an AI model, a neural network, etc.), to automatically generate a model card to associate with the model. As described herein, the information associated with the model may include at least a portion of source code used to generate the model, one or more documents that describe the model, one or more previously generated model cards, and/or any other information associated with the model. Additionally, in some examples, additional data may be input into the language model(s) to generate the model card, such as data representing queries (e.g., questions) for retrieving relevant information needed to generate the model card, data representing a format for the model card (e.g., if this is a new model card), and/or data representing reference information associated with one or more other models.

In contrast to conventional systems, such as the conventional systems described above, the systems of the present disclosure may use the language model(s) to automatically generate model cards for models. As such, and in contrast to the conventional systems, users may not need to manually identify the information that is needed to generate the model cards and/or input the relevant portions of the information into the model cards, which may save time and/or computing resources. Additionally, in contrast to the conventional systems, the systems of the present disclosure may be used to automatically update model cards, such as when updates occur to the models (e.g., the models are further trained to be more accurate and/or to perform additional processing tasks), without users again needing to input the information into the model cards. As described herein, by performing these processes to automatically generate and/or update model cards, the model cards may also be more current and accurate since the generating and/or updating of the models cards is not prone to user error.

### BRIEF DESCRIPTION OF THE DRAWINGS

The present systems and methods for automatic model card generation for machine learning models are described in detail below with reference to the attached drawing figures, wherein:

FIG. 1A illustrates an example of a process for generating a new model card associated with a model, in accordance with some embodiments of the present disclosure;

FIG. 1B illustrates an example of a process for updating a model card associated with a model, in accordance with some embodiments of the present disclosure;

FIG. 1C illustrates an example of a process for verifying a model card associated with a model, in accordance with some embodiments of the present disclosure;

FIG. 2 illustrates an example of retrieving information for generating a model card associated with a model, in accordance with some embodiments of the present disclosure;

FIG. 3 illustrates an example of retrieving reference information for generating a model card associated with a model, in accordance with some embodiments of the present disclosure;

FIG. 4 illustrates an example of a model card that may be associated with a model, in accordance with some embodiments of the present disclosure;

FIG. 5 illustrates an example of updating the model card associated with the model from the example of FIG. 4, in accordance with some embodiments of the present disclosure;

FIG. 6 illustrates an example of one or more systems that may use model cards to perform various tasks, in accordance with some embodiments of the present disclosure;

FIG. 7 illustrates a flow diagram showing a method for generating a new model card associated with a model, in accordance with some embodiments of the present disclosure;

FIG. 8 illustrates a flow diagram showing a method for updating a model card associated with a model, in accordance with some embodiments of the present disclosure;

FIG. 9 illustrates a flow diagram showing a method for verifying a model card associated with a model, in accordance with some embodiments of the present disclosure;

FIG. 10 illustrates a flow diagram showing a method for generating a model card that is then used to determine whether to provide a model to one or more computing devices, in accordance with some embodiments of the present disclosure;

FIG. 11A is a block diagram of an example generative language model system suitable for use in implementing some embodiments of the present disclosure;

FIG. 11B is a block diagram of an example generative language model that includes a transformer encoder-decoder suitable for use in implementing some embodiments of the present disclosure;

FIG. 11C is a block diagram of an example generative language model that includes a decoder-only transformer architecture suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Systems and methods are disclosed related to automatic model card generation for machine learning models. For instance, a system(s) may obtain, receive, retrieve, and/or store data associated with one or more models within one or more databases. As described herein, the data for a model may include, but is not limited to, data for executing the model, data representing one or more model cards associated with the model (e.g., if previously generated), and/or data representing information associated with the model, such as source code associated with the model, one or more documents (e.g., one or more research papers, one or more summaries, etc.) describing the model, and/or any other information. When describing information associated with models, in order to differentiate the different types of information that may be used to generate a model card, the information associated with the model for which the model card is being generated may be referred to as “primary information” while the information associated with one or more other, reference models may be referred to as “reference information.”

In some examples, the system(s) may store at least a portion of the data using one or more formats. For example, the system(s) may segment the information into various portions, such as letters, numbers, words, sentences, paragraphs, code snippets, and/or any other portion of text, where the portions of information may be referred to as “chunks” of information. The system(s) may then process the chunks of information using one or more embedding components (e.g., one or more machine learning models, one or more neural networks, one or more transformers, one or more encoders, etc.) in order to generate embeddings (and/or vectors) associated with the chunks of information. Additionally, the system(s) may then store the embeddings and/or the chunks of information in the database(s). As described further herein, the system(s) may store the information using such a format in order to improve later processing that is used to extract relevant portions of the information.

In some examples, the system(s) may then use data associated with one or models to generate at least a model card associated with a model. For instance, the system(s) may obtain, receive, retrieve, and/or store data representing queries (e.g., questions) associated with extracting primary information associated with the model. In some examples, at least a portion of the queries may be specific to a format associated with the model card being generated, such as one or more queries to extract primary information related to fields included in the model card. For example, the queries may be to extract primary information for attributes associated with the model, intended use cases of the model, out-of-scope applications for the model, inputs to the model, outputs of the model, expected users of the model, how the model will perform with different groups, training of the model, limitations of the model, computing requirements for the model, and/or the like. Additionally, or alternatively, in some examples, at least a portion of the queries may be specific to a type of the model, such as one or more queries to extract primary information that is relevant to the use (e.g., tasks) of the model (e.g., transportation-related model queries, language-related model queries, etc.).

The system(s) may then use the queries to retrieve at least a portion of the primary information that is associated with the model. For instance, the system(s) may use the embedding component(s) to generate embeddings associated with the queries. The system(s) may then use the generated embeddings to identify stored embeddings associated with the primary information that is related to the queries. For example, and for a generated embedding associated with a query, the system(s) may use the generated embedding to identify a number of stored embeddings that are most closely related to the generated embedding. As described herein, the number of stored embeddings may include, but is not limited to, one embedding, two embeddings, five embeddings, ten embeddings, twenty embeddings, and/or any other number of embeddings. In some examples, an embedding and/or a chunk of primary information (e.g., source code, a document, a model card, etc.) associated with the embedding may be referred to as a “primary chunk.”

The system(s) may then perform a first processing task, such as based on a first call, that includes using one or more language models to process input data. As described herein, the input data may represent at least the primary information (e.g., the source code, the documents, etc.) associated with the model, the identified chunks of the primary information, and/or the queries. In some examples, the input data may represent the actual text associated with the primary information, the identified chunks of the primary information, and/or the queries. Additionally, or alternatively, in some examples, the input data may represent the embeddings associated with the primary information, the identified chunks of the primary information, and/or the queries. Still, in some examples, the input data may further represent a prompt, such as a prompt to generate and/or output specific data. In any of these examples, the language model(s) may generate an initial output, such as an initial output representing information associated with the queries.

In some examples, the system(s) may then use the primary information (e.g., the primary chunks) associated with the model to retrieve reference information associated with one or more reference models. As described herein, the system(s) may use one or more techniques to retrieve the reference information. For example, the system(s) may use the retrieved embeddings associated with the primary information to identify a number of additional embeddings associated with the reference information that are most closely related to the retrieved embeddings. As described herein, the number of additional embeddings may include, but is not limited to, one embedding, two embeddings, five embeddings, ten embeddings, twenty embeddings, and/or any other number of embeddings. In some examples, an additional embedding and/or a portion of reference information (e.g., source code, a document, a model card, etc.) associated with the additional embedding may be referred to as a “reference chunk.”

In some examples, such as if the system(s) is generating a new model card for the model, the system(s) may retrieve a model card template representing a format for the model card. For instance, the model card template may indicate fields for different types of information to include in the model card, such as fields for attributes, intended use cases, out-of-scope applications, inputs, outputs, expected users, model performance for different groups, training, limitations, computing requirements, and/or the like. As described herein, an attribute may include, but is not limited to, a name and/or an identifier of the model, one or more names and/or identifiers of one or more datasets used to train the model, one or more sizes of the dataset(s), a number of epochs using for the training, a license type associated with the model, one or more risk scores associated with the model, one or more bias scores associated with the model, one or more losses associated with the model, and/or any other type of attribute. Additionally, or alternatively, in some examples, such as when the system(s) is updating a previously generated model card for the model, the system(s) may retrieve the existing model card from the database(s).

The system(s) may then perform a second processing task, such as based on a second call, that includes using the language model(s) to process additional input data. As described herein, the additional input data may represent at least the initial output from the language model(s) during the first processing task (e.g., the information associated with the queries), the reference information (e.g., the portions of source code, documents, model cards, etc.) associated with the reference model(s), the previously generated model card, and/or the model card template. In some examples, the additional input data may represent the actual text associated with the initial output, reference information, the previously generated model card, and/or the model card template. Additionally, or alternatively, in some examples, the additional input may represent the embeddings associated with the initial output, the reference information, the existing model card, and/or the model card template.

In examples where the system(s) is generating a new model card for the model, the language model(s) may generate an output representing the model card. For instance, the model card may include the format associated with the model card template, such as by including the information associated with the various fields. However, in examples where the system(s) is updating the existing model card for the model, the language model(s) may generate an output representing the existing model card as updated. For instance, the update model card may include updated information for one or more of the fields. For example, if the model was further trained using a new dataset, then the model card may be updated to include information associated with the further training and/or the new dataset. The system(s) may then store the new model card and/or the updated model card in association with the model, such as in the database(s).

While these examples describe using the language model(s) to generate a new model card and/or update an existing model card, in other examples, the system(s) may use the language model(s) to perform one or more additional processes with respect to model cards, such as verifying an existing model card. For example, such as during the second processing task, the language model(s) may process the additional input data that represents the initial output from the language model(s), the reference information, and/or the existing model card. Based at least on the processing, the language model(s) may determine whether the information included in the existing model card is accurate. Additionally, the language model(s) may then generate an output indicating that (1) the existing model card is not verified if the information is inaccurate or (2) the existing model card is verified if the information is accurate. In such examples, if the existing model card is not verified, the language model(s) may further output data indicating which information associated with the existing model card is inaccurate and/or representing updated information for the model card.

Additionally, while the examples herein describe generating a single model card associated with a single model, in other examples, similar processes may be used to generate any number of model cards associated with any number of models. For a first example, when multiple models are included in a processing pipeline, the system(s) may perform similar processes to generate a single model card associated with the processing pipeline. In such an example, the model card may include information describing the individual models included in the pipeline and/or information describing the entire pipeline. For a second example, and again when multiple models are included in a processing pipeline, the system(s) may generate multiple model cards associated with the pipeline. In such an example, one or more model cards may include information describing one or more of the models and/or a model card may include information describing the entire pipeline.

In some examples, the system(s) may perform one or more additional processes using the model card (e.g., the new model card, the updated model card, etc.) for the model. For instance, the system(s) may receive, from one or more endpoints, a request to execute a model on one or more devices associated with the endpoint(s). In some examples, the request may indicate a specific model of the model(s) that the endpoint(s) is/are requesting to execute. Based at least on the request, the system(s) may obtain at least the model card stored in association with that specific model. Using the model card and the information known about the requesting endpoint(s), the system(s) may determine whether to provide the model to the endpoint.

In some examples, the system(s) may evaluate the attribute(s) and/or other information included in the model card with respect to one or more criteria associated with the endpoint(s). For instance, the criteria may include a policy associated with the endpoint(s) (e.g., an enterprise policy, etc.) that indicates various requirements for the model(s) that may be used. As an example, the policy may indicate, among other things, risk thresholds for models, license requirements for models, training requirements for models, etc. Additionally, or alternatively, the criteria may include hardware specifications indicating one or more limitations and/or capabilities associated with the device(s) of the endpoint(s) that is to execute the model(s). For instance, the hardware specification may indicate features (e.g., type of processor, make of processor, model of processor, etc.) associated with one or more processors of the device(s), memory limitations and/or capabilities associated with the device(s), version numbers associated with the device(s), etc.

In some examples, the system(s) may determine that the endpoint(s) and/or device(s) is allowed and/or capable of executing the requested model. For instance, based at least on the evaluation, the system(s) may determine that the model is in compliance with a given set of requirements (e.g., which may be indicated in the policy), that the model is optimized for the execution environment of the endpoint(s), and that the device(s) hardware is able to properly execute the model. The system(s) may then send, to the endpoint, data for executing the model on the device(s). Additionally, or alternatively, if the system(s) determine that the endpoint(s) and/or device(s) are prevented from executing the model, the system may send an indication to the endpoint(s). In some examples, the indication may indicate one or more reasons why the model is prevented from executing on the endpoint(s). For example, the indication may indicate that the policy restricts the endpoint(s) from executing the requested model and/or that the capabilities/limitations of the device(s) may prevent the requested model from being executed.

For example, the model card may indicate a risk score associated with the requested model, and the system(s) may evaluate this risk score with respect to a risk threshold associated with the endpoint(s) (e.g., indicated in the policy). Based at least on the evaluation, the system(s) may determine whether or not to provide the data to the endpoint(s) for executing the model. That is, if the model risk score meets or exceeds the risk threshold, the system(s) may determine to preclude the model from execution on the endpoint(s). However, if the model risk score is less than the risk threshold, the system(s) may determine to allow the model to be executed by the endpoint(s).

As another example, the system(s) may determine, based at least on the model card, one or more thresholds corresponding to one or more hardware capabilities for executing the model. Example thresholds may include, but are not limited to, a central processing unit (CPU) threshold, a graphics processing unit (GPU) threshold, a data processing unit (DPU) threshold, a network hardware unit threshold, a memory threshold, and a network bandwidth threshold. The system(s) may then evaluate actual capabilities associated with the device(s) of the endpoint(s) with respect to the one or more hardware threshold(s) to determine whether or not to provide the data to the endpoint(s) for executing the model. If the system(s) determine the actual capabilities meet or exceed the threshold(s), the system(s) may determine to provide the model to the endpoint(s). However, if the actual capabilities do not meet the threshold(s), the system(s) may determine to prevent the model from being executed by the endpoint(s).

In some examples, the system(s) may propose one or more alternatives (e.g., better suited, more capable, etc.) model to the endpoint(s). In some examples, the alternative model(s) may be proposed to the endpoint(s) based at least on determining that the endpoint(s) is prevented from executing a requested model. Additionally, or alternatively, the endpoint(s) may query the system(s) for a model(s) that meet certain prerequisites, for intended purposes, etc. By way of example, and not limitation, the endpoint(s) may request a model for detecting objects in an environment of a machine, that has been trained using a closed source (e.g., non-open source) dataset, and that is optimized for rural environments. Based on this request, the system(s) may evaluate one or more model cards for one or more proposed models that would meet these requirements. In some examples, the system(s) may further provide the model card(s) corresponding to the proposed model(s) to the endpoint(s), and the endpoint(s) may select which model(s) to execute.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more visual language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

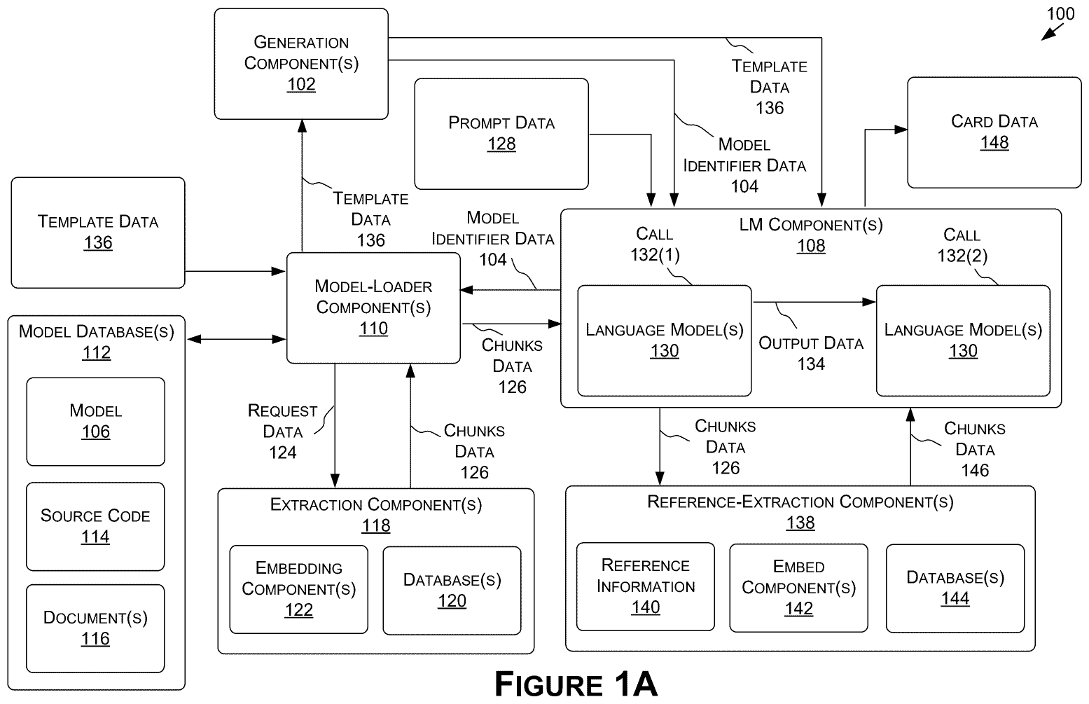

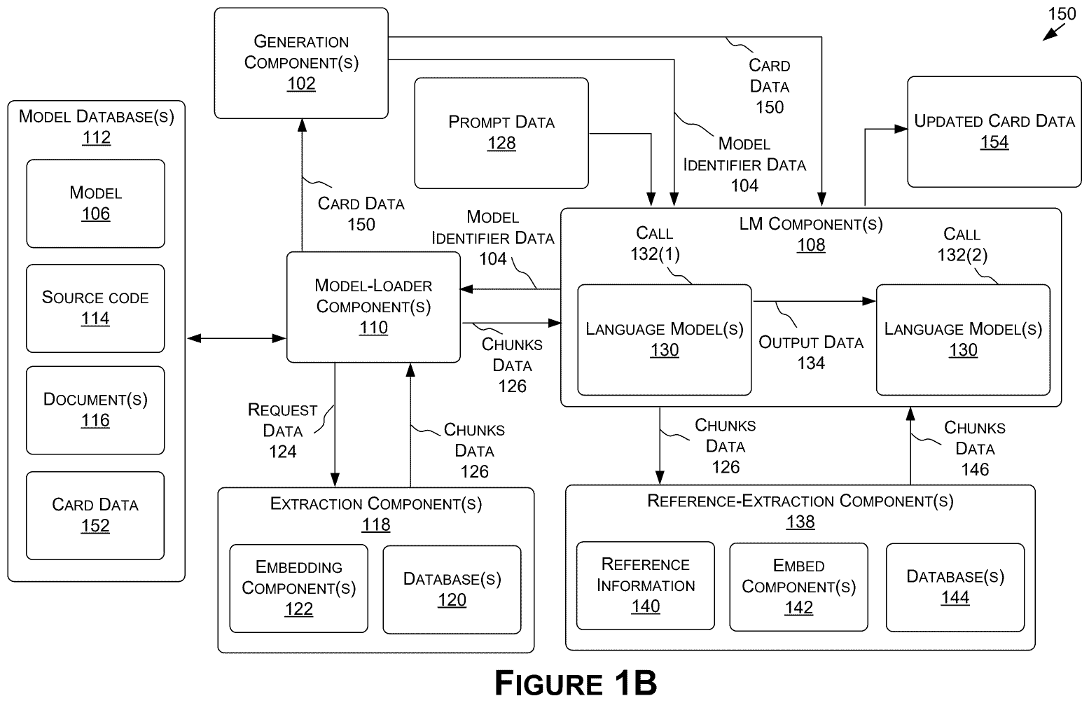

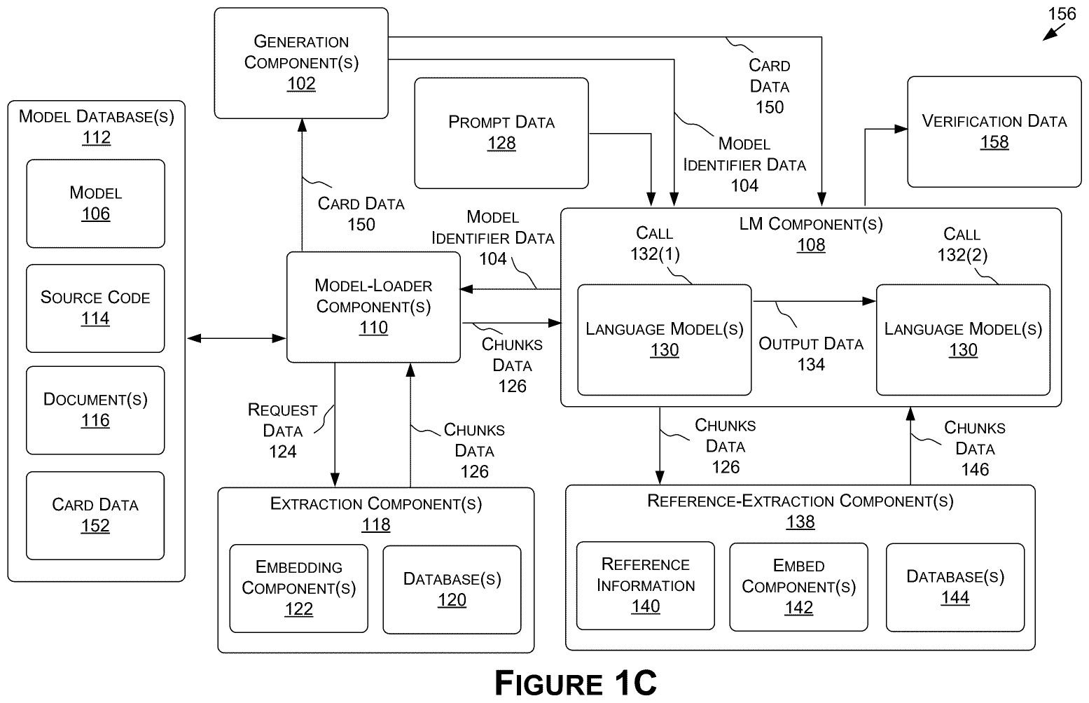

With reference to FIG. 1A illustrates an example of a process 100 for generating a new model card associated with a model, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more generation components 102 sending model identifier data 104 associated with a model 106 to one or more language model (LM) components 108. As described herein, in some examples, the model identifier data 104 may represent any type of identifier associated with the model 106, such as a name, a label, an alphabetic identifier, a numerical identifier, an alphanumeric identifier, a code, and/or so forth. Additionally, in some examples, the model identifier data 104 may represent information for locating and/or retrieving the model 106 and/or primary information associated with the model 106. For example, the model identifier data 104 may represent a uniform resource locator (URL) and/or any other type of locator for retrieving the model 106 and/or the primary information associated with the model 106. Based at least on receiving the model identifier data 104, the LM component(s) 108 may then send the model identifier data 104 to one or more model-loader components 110.

The process 100 may then include the model-loader component(s) 110 using the model identifier data 104 to retrieve primary information associated with the model 106. For instance, and as shown, one or more model databases 112 may store the primary information associated with the model 106, such as source code 114 associated with the model 106 and/or one or more documents 116 associated with the model 106. As described herein, a document 116 may include, but is not limited to, a research paper, an article, a summary, a manual, text, and/or any other source of information associated with the model 106. Additionally, at least a portion of the primary information may describe attributes, intended use cases, out-of-scope applications, inputs to the model, outputs of the model, expected users, model performance for different groups, training, limitations, computing requirements, and/or any other information associated with the model 106. As such, the model-loader component(s) 110 may use the model identifier data 104 to retrieve at least the source code 114 and the document(s) 116 from the model database(s) 112.

In some examples, the process 100 may including one or more extraction components 118 segmenting the source code 114 and/or the document(s) 116 into chunks, such as letters, numbers, words, sentences, paragraphs, code snippets, and/or any other portion of text. The extraction component(s) 118 may then store the chunks in one or more databases 120 (e.g., the extraction component(s) 118 may perform code ingestion). In some examples, the extraction component(s) 118 may perform additional and/or alternative processes, such as generating embeddings associated with the chunks using one or more embedding components 122. In such examples, the extraction component(s) 118 may further store the embeddings in the database(s) 120.

The process 100 may then include the model-loader component(s) 110 sending a request to extract at least a portion of the retrieved information to the extraction component(s) 118, where the request may be represented by request data 124 As described herein, the request data 124 may represent one or more queries related to specific types of information to extract. In some examples, at least a portion of the queries may be specific to a format associated with the model card being generated, such as one or more questions to extract primary information that should be included within the model card. For example, the queries may be to extract information for attributes associated with the model 106, intended use cases of the model 106, out-of-scope applications for the model 106, expected users of the model 106, how the model 106 will perform with different groups, training of the model 106, limitations of the model 106, computing requirements for the model 106, and/or the like. Additionally, in some examples, at least a portion of the queries may be specific to a type of the model 106, such as one or more queries to extract primary information that is relevant to the use of the model 106 (e.g., transportation-related models, language-related models, etc.).

For a first example, such as to retrieve primary information associated with the functionality of the source code 114, a query may include “Could you describe the functionality of the code. ” For a second example, such as to retrieve primary information associated with a description of the model 106, a query may include “Describe what this model does, including supporting images and articles that are available. ” For a third example, such as to retrieve primary information associated with an architecture of the model 106, a query may include “What is the architecture type of the neural network used in the model. ” For a fourth example, such as to retrieve primary information associated with an input type of the model 106, a query may include “What type of input data does the model expect, audio, image, text, or anything else. ” Still, for a fifth example, such as to retrieve primary information associated with a training set of the model 106, a query may include “What datasets were used for training the model. ” While these are just a few example queries for retrieving primary information associated with the model 106, in other examples, additional and/or alternative queries may be used to retrieve additional and/or alternative types of primary information associated with the model 106.

To extract the portions of primary information, also referred to as chunks, the extraction component(s) 118 may use one or more embedding components 122 to generate embeddings associated with various chunks of the primary information. As described herein, the embedding component(s) 122 may include and/or use one or more machine learning models, one or more neural networks, one or more transformers, one or more encoders, and/or any other type of component that is configured to partition the primary information into the chunks and/or generate the embeddings associated with the chunks. The extraction component(s) 118 may then store the embeddings (and/or the chunks) in the database(s) 120, such as a vector database (and/or any other type of database).

Additionally, the extraction component(s) 118 may use the embedding component(s) 122 to generate embeddings (also referred to as “query embeddings”) associated with the queries represented by the request data 124. The extraction component(s) 118 may then use the query embeddings to retrieve one or more chunks of information that are relevant for generating the model card associated with the model 106. For instance, and for a query embedding, the extraction component(s) 118 may analyze the query embedding with respect to the embeddings stored in the database(s) 120 to identify a number of embeddings that are related to the query embedding. As described herein, the number of embeddings may include, but is not limited to, one embedding, two embeddings, five embeddings, ten embeddings, twenty embeddings, and/or any other number of embeddings. Additionally, the extraction component(s) 118 may perform any technique to identify the number of embeddings, such as identifying the embeddings that are most closely related to the query embedding based at least on distances between vectors associated with the embeddings and a vector associated with the query embedding in a latent space.

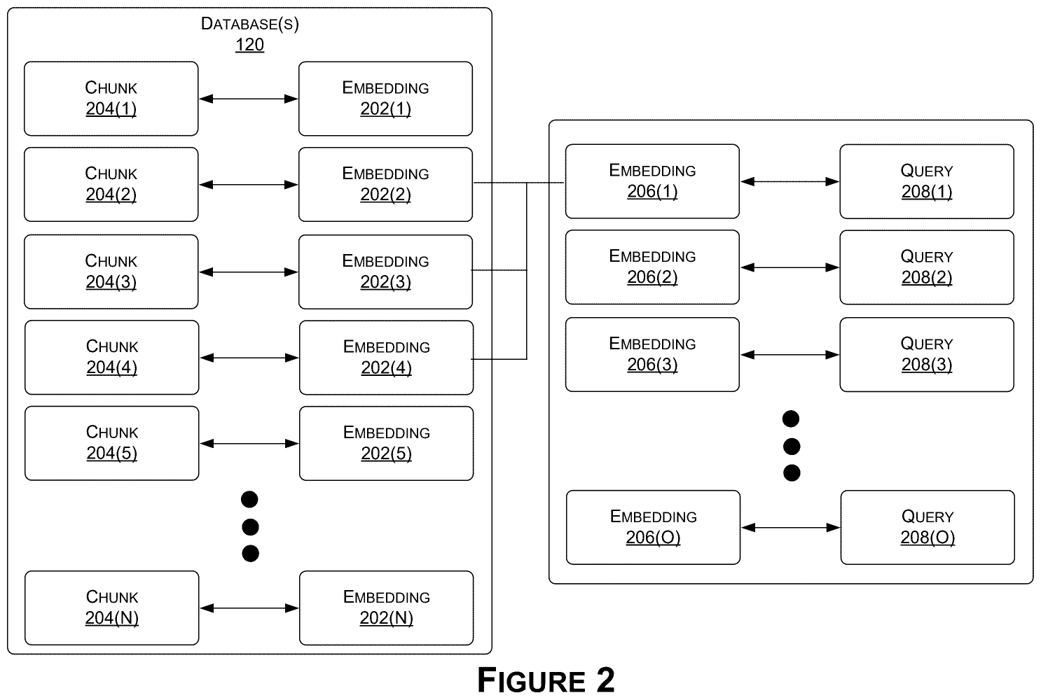

For instance, FIG. 2 illustrates an example of retrieving information for generating a model card associated with a model, in accordance with some embodiments of the present disclosure. As shown, the extraction component(s) 118 may generate embeddings 202(1)-(N) (also referred to singularly as “embedding 202” or in plural as “embeddings 202”) associated with chunks 204(1)-(N) (also referred to singularly as “chunk 204” or in plural as “chunks 204”) of primary information. As described herein, a chunk 204 may include a portion of primary information, such as a portion of source code and/or a portion of a document associated with the model. Additionally, the extraction component(s) 118 may generate embeddings 206(1)-(O) (also referred to singularly as “embedding 206” or in plural as “embeddings 206”) associated with queries 208(1)-(O) (also referred to singularly as “query 208”or in plural as “queries 208”).

The extraction component(s) 118 may then analyze the embeddings 206 with respect to the embeddings 202 in order to identify at least a portion of the embeddings 202 that are related to the embeddings 206. For instance, and as shown, the extraction component(s) 118 may perform one or more techniques to determine that the embeddings 202(2)-(4) are related to the embedding 206(1). For example, the extraction component(s) 118 may determine that the embeddings 202(2)-(4) includes the closest embeddings 202 to the embedding 206(1) within a latent space. In other words, the extraction component(s) 118 may use the embeddings 202(2)-(4) and the embedding 206(1) to determine that the chunks 204(2)-(4) of primary information are related to the query 208(1). The extraction component(s) 118 may then perform similar processes for each of the other embeddings 206(2)-(O).

Referring back to the example of FIG. 1A, the process 100 may include the model-loader component(s) 110 retrieving chunks data 126 from the extraction component(s) 118. In some examples, the chunks data 126 may represent the actual chunks of primary information (e.g., one or more portions of the source code 114, one or more portions of the document(s) 116, etc.) while, in some examples, the chunks data 126 may represent the embeddings associated with the chunks. The process 100 may then include the model-loader component(s) 110 providing the chunks data 126 to the LM component(s) 108. Additionally, in some examples, the process 100 may include the LM component(s) 108 receiving prompt data 128, where the prompt data 128 represents at least a prompt to extract information for generating the model card. For example, the prompt may instruct one or more language models 130 to identify necessary information to generate the model card, one or more indications of one or more fields of the model card for which information needs to be retrieved, one or more indications of the data (e.g., the chunks data 126) for which the information may be retrieved, and/or any other instructions associated with retrieving the information.

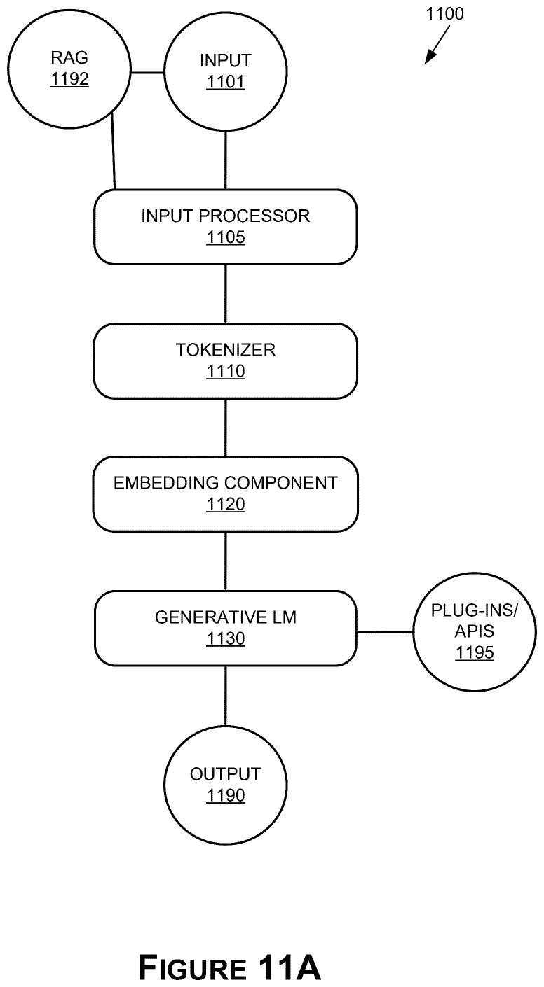

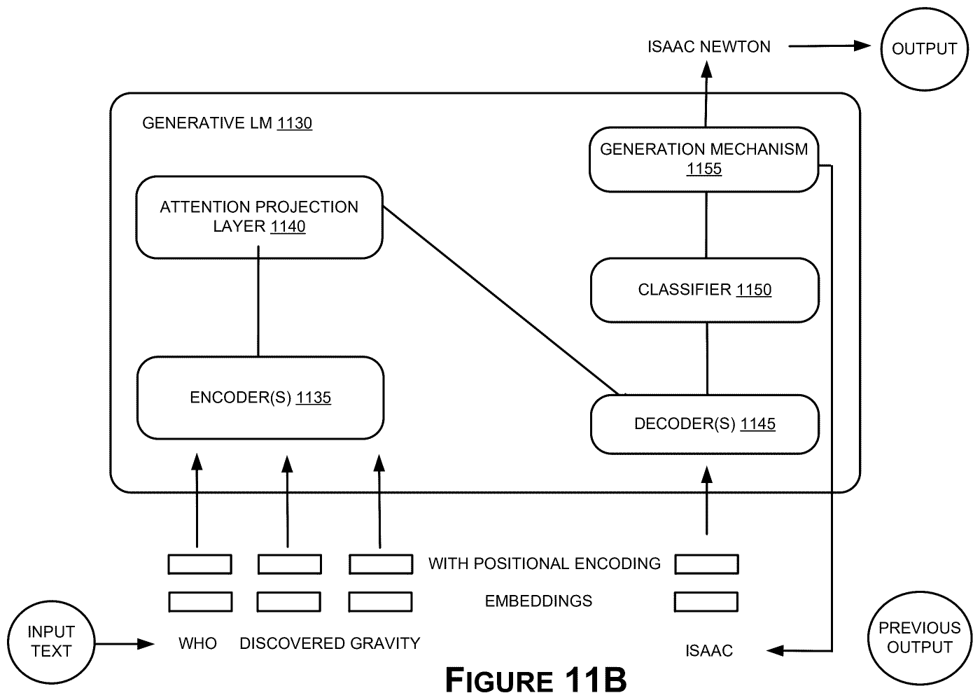

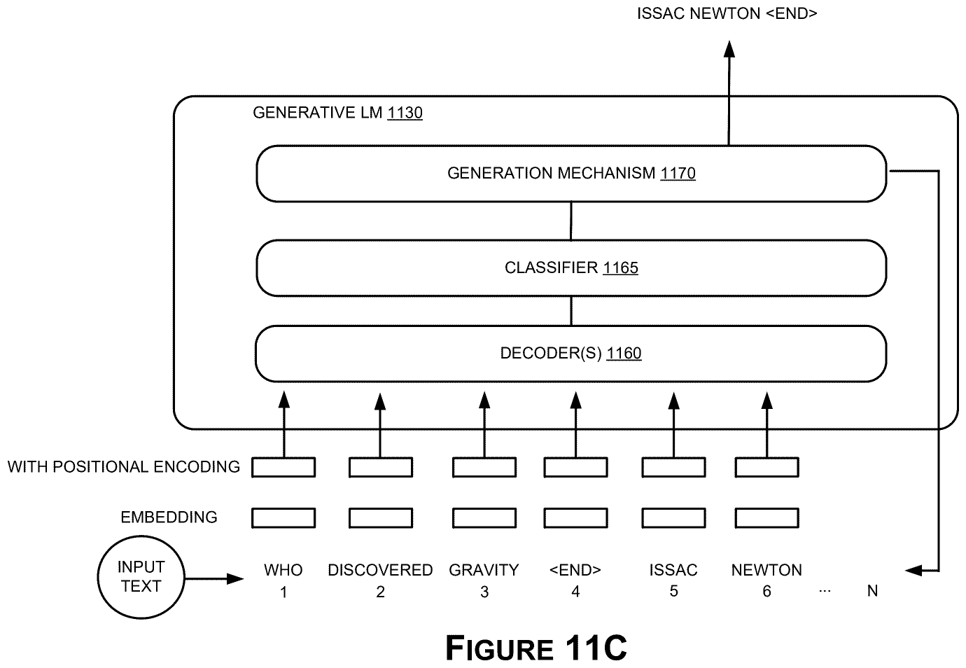

The process 100 may then include the language model(s) 130 processing at least the prompt data 128 and the chunks data 126 during a first processing task, where the first processing task may be associated with a first call 132(1). In some examples, the language model(s) 130 may perform any type of processing, such as the processing described herein with respect to FIGS. 11A-11C. Based at least on the processing, the process 100 may include the language model(s) 130 generating and/or outputting data 134 associated with the first processing task. For instance, the output data 134 may represent at least a portion of the primary information that may be needed to generate the model card associated with the model 106. For example, the output data 134 may represent primary information related to the attributes associated with the model 106, intended use cases of the model 106, out-of-scope applications for the model 106, inputs to the model 106, outputs of the model 106, expected users of the model 106, how the model 106 will perform with different groups, training of the model 106, limitations of the model 106, computing requirements for the model 106, and/or any other information that may be included in the model card.

In some examples, since the example of FIG. 1A is associated with generating a new model card associated with the model 106, the process 100 may include the model-loader component(s) 110 receiving template data 136 representing a model card template for generating the new model card. As described herein, the model card template may represent a format for model cards, such as fields of information to include in the model card and/or a layout for the fields (e.g., an order that the fields are included within the model cards). For example, the model card template may indicate whether to include information for attributes associated with the model 106, intended use cases of the model 106, out-of-scope applications for the model 106, inputs to the model 106, outputs of the model 106, expected users of the model 106, how the model 106 will perform with different groups, training of the model 106, limitations of the model 106, computing requirements for the model 106, and/or any other information that may be included in the model card.

The process 100 may then include the model-loader component(s) 110 sending the template data 136 to the generation component(s) 102, which then sends the template data 136 to the LM component(s) 108. This way, the LM component(s) 108 may use the template data 136 to determine the format for generating the model card associated with the model 106, which is described in more detail herein.

In some examples, and as further illustrated by the example of FIG. 1A, the process 100 may include the LM component(s) 108 extracting additional information, such as reference information, using one or more reference-extraction components 138. For instance, the reference-extraction component(s) 138 may store reference information 140 associated with one or more reference models. As described herein, the reference information 140 associated with a reference model may include, but is not limited to, source code associated with the reference model, one or more documents associated with the reference model, a model card associated with the reference model, and/or any other information. Additionally, similar to a document 116, a document associated with the reference information 140 may include, but is not limited to, a research paper, an article, a summary, a manual, text, and/or any other source of information associated with the reference model.

In some examples, the reference-extraction component(s) 138 may then use one or more embedding components 142 to generate embeddings associated with various portions of the reference information 140, where the portions of the reference information 140 may be referred to as “reference chunks” of the reference information 140. As described herein, the embedding component(s) 142 may include and/or use one or more machine learning models, one or more neural networks, one or more transformers, one or more encoders, and/or any other type of component that is configured to partition the reference information 140 into the reference chunks and/or generate the embeddings associated with the reference chunks. The reference-extraction component(s) 138 may then store the embeddings (and/or the reference chunks) in one or more databases 144, such as a vector database (and/or any other type of database).

The reference-extraction component(s) 138 may then use the chunks data 126 to retrieve one or more reference chunks that adare relevant for generating the model card associated with the model 106. For instance, and for an individual chunk and/or an individual embedding represented by the chunks data 126, the reference-extraction component(s) 138 may analyze the individual embedding with respect to the embeddings stored in the database(s) 144 to identify a number of embeddings that are related to the individual embedding. As described herein, the number of embeddings may include, but is not limited to, one embedding, two embeddings, five embeddings, ten embeddings, twenty embeddings, and/or any other number of embeddings. Additionally, the reference-extraction component(s) 138 may perform any technique to identify the number of embeddings, such as identifying the embeddings that are most closely related to the individual embedding based on distances between vectors associated with the embeddings and a vector associated with the individual embedding in a latent space.

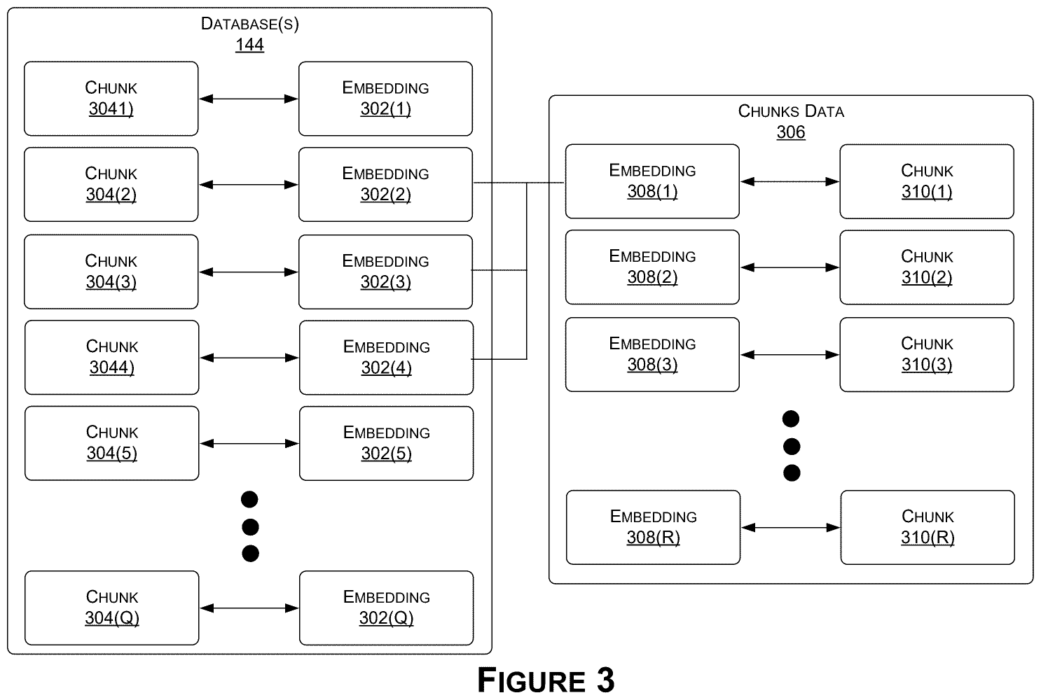

For instance, FIG. 3 illustrates an example of retrieving reference information for generating a model card associated with a model, in accordance with some embodiments of the present disclosure. As shown, the reference-extraction component(s) 138 may generate embeddings 302(1)-(Q) (also referred to singularly as “embedding 302” or in plural as “embeddings 302”) associated with reference chunks 304(1)-(Q) (also referred to singularly as “chunk 304” or in plural as “chunks 304”) of reference information. As described herein, a reference chunk 304 may include a portion of the reference information 140, such as a portion of source code, a portion of a document, and/or a portion of a model card associated with a reference model. Additionally, the reference-extraction component(s) 138 may receive chunks data 306 (which may represent, and/or be similar to, the chunks data 126) that represents embeddings 308(1)-(R) (also referred to singularly as “embedding 308” or in plural as “embeddings 308”) associated with chunks 310(1)-(R) (also referred to singularly as “chunk 310” or in plural as “chunks 310”) of the primary information.

The reference-extraction component(s) 138 may then analyze the embeddings 308 with respect to the embeddings 302 in order to identify at least a portion of the embeddings 302 that are related to the embeddings 308. For instance, and as shown, the reference-extraction component(s) 138 may perform one or more techniques to determine that the embeddings 302(2)-(4) are related to the embedding 308(1). For example, the reference-extraction component(s) 138 may determine that the embeddings 302(2)-(4) include the closest embeddings 302 to the embedding 308(1) within a latent space. In other words, the reference-extraction component(s) 138 may use the embeddings 302(2)-(4) and the embedding 308(1) to determine that the reference chunks 304(2)-(4) of reference information may be related to the primary chunk 310(1) of primary information associated with the model for which the model card is being generated. The reference-extraction component(s) 138 may then perform similar processes for each of the other embeddings 308(2)-(S).

Referring back to the example of FIG. 1A, the process 100 may include the LM component(s) 108 retrieving chunks data 146 from the reference-extraction component(s) 138. In some examples, the chunks data 146 may represent the reference chunks of the reference information 140, such as one or more portions of the source code, one or more portions of the document(s), one or more portions of the model card(s), and/or any other portion of the reference information 140. Additionally, or alternatively, in some examples, the chunks data 146 may represent the embeddings associated with the reference chunks of the reference information 140.

The process 100 may then include the language model(s) 130 processing at least the output data 134, the template data 136, and/or the chunks data 146, such as during a second processing task that is associated with a second call 132(2). In some examples, the language model(s) 130 may perform any type of processing, such as the processing described herein with respect to FIGS. 11A-11C. Based at least on the processing, the process 100 may include the language model(s) 130 generating and/or outputting card data 148 (e.g., metadata, etc.) associated with the second processing task. For instance, the card data 148 may represent at least the model card associated with the model 106. As described herein, since the model card is generated using at least the output data 134 and the template data 136, the model card may include the format of the template model card and the information represented by the output data 134.

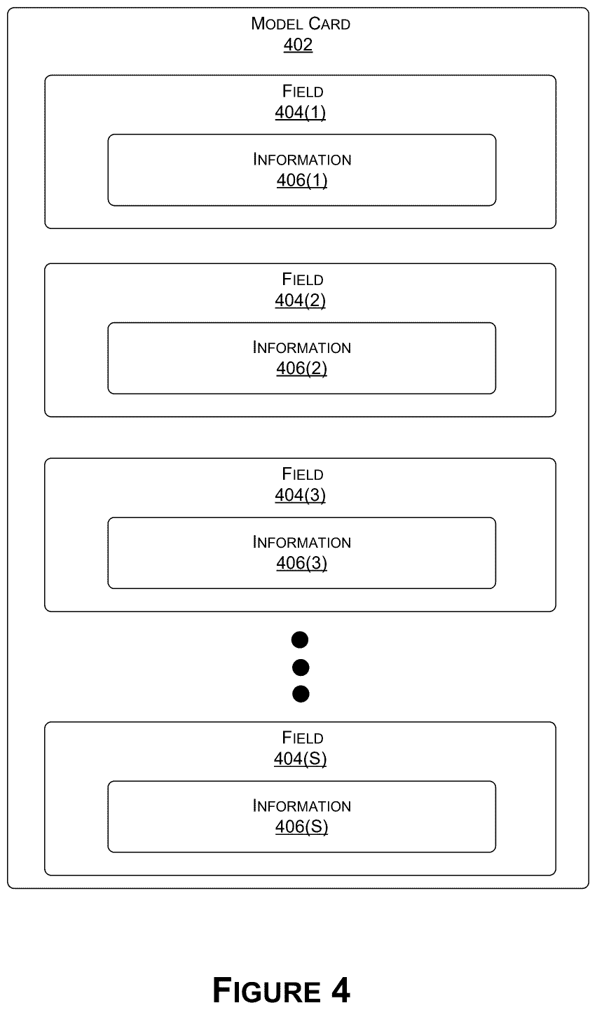

For instance, FIG. 4 illustrates an example of a model card 402 (which may be represented by the card data 148) that may be associated with a model, in accordance with some embodiments of the present disclosure. As shown, the model card 402 may include various fields 404(1)-(S) (also referred to singularly as “field 404” or in plural as “fields 404”), where each field 404 may be associated with a type of information corresponding to the model. For example, a field 404 may be associated with an attribute (e.g., a name and/or identifier of the model, a name and/or identifier of a dataset, a size of the dataset, etc.) associated with the model, intended use cases of the model, out-of-scope applications for the model, inputs to the model, outputs of the model, expected users of the model, how the model will perform with different groups, training of the model, limitations of the model, computing requirements for the model, and/or any other information that may be included in the model card 402. The model card 402 may then include information 406(1)-(S) (also referred to as “information 406”) describing the model with respect to the fields.

For example, a field 404 may be associated with a description of the model and information 406 may describe the model (e.g., using text, images, a video, etc.), a field 404 may be associated with a license and/or terms of use of the model and information 406 may describe the license and/or terms, a field 404 may be associated with a model architecture and information 406 may describe the model architecture (e.g., describe the neural network associated with the model, such as type), a field 404 may be associated with inputs to the model and information 406 may describe the types of inputs for the model (e.g., text, images, tokens, audio, etc., a field 404 may be associated with outputs of the model and information 406 may describe the types of outputs and/or details about the outputs, a field 404 may be associated with a version of the model and information 406 may describe the version, and/or a field 404 may be associated with datasets used to train the model and information 406 may describe the datasets (e.g., identifiers of the datasets, how data examples in the datasets were collected, how the dataset were labeled, how the datasets were tested, how the datasets were evaluated, etc.). While these are just a few examples of fields that may be included in the model 402, in other examples, any other type of field may be included in the model 402.

As described herein, in some examples, a model card may have already been generated for the model 106, where the model card needs to be updated based on the occurrence of one or more events. For example, if the model 106 is updated, such as with a new name, new training (e.g., a new dataset), a new intended use, a new limitation, a new computing requirement, and/or the like, then the model card may need to be updated to reflect one or more of these updates to the model 106. As such, FIG. 1B illustrates an example of a process 150 for updating a model card associated with a model, in accordance with some embodiments of the present disclosure.

As shown, the process 150 may be similar to the process 100 except, in the example of FIG. 1B, the model 106 may have already been associated with a previously generated model card, where the previously generated model card is represented by card data 152. As such, instead of the model-loader component(s) 110 receiving the template data 136 as with the example of FIG. 1A, the model-loader component(s) 110 may instead retrieve the card data 152 representing the previously generated model card and send the card data 152 to the generation component(s) 102. Additionally, the generation component(s) 102 may then send the card data 152 to the LM component(s) 108 that then uses the card data 152 to update the previously generated model card, such as with new information.

For instance, the process 150 may include the language model(s) 130 processing at least the output data 134, the chunks data 146, and the card data 152, such as during the second processing task associated with the second call 132(2). In some examples, the language model(s) 130 may perform any type of processing, such as the processing described herein with respect to FIGS. 11A-11C. Based at least on the processing, the process 150 may include the language model(s) 130 generating and/or outputting updated card data 154 associated with the second processing task. For instance, the updated card data 154 may represent at least the previously generated model card associated with the model 106 as updated. As described herein, in some examples, the language model(s) 130 may update the information associated with one or more fields of the model card. For example, the language model(s) 130 may update the information associated with the attribute(s) (e.g., a name and/or identifier of the model, a name and/or identifier of the dataset, a size of the dataset, etc.) associated with the model 106, the intended use case(s) of the model 106, out-of-scope application(s) for the model 106, inputs to the model 106, outputs of the model 106, the expected user(s) of the model 106, how the model 106 will perform with different groups, the training of the model(s), the limitation(s) of the model 106, the computing requirement(s) for the model 106, and/or any other information that may be included in the model card.

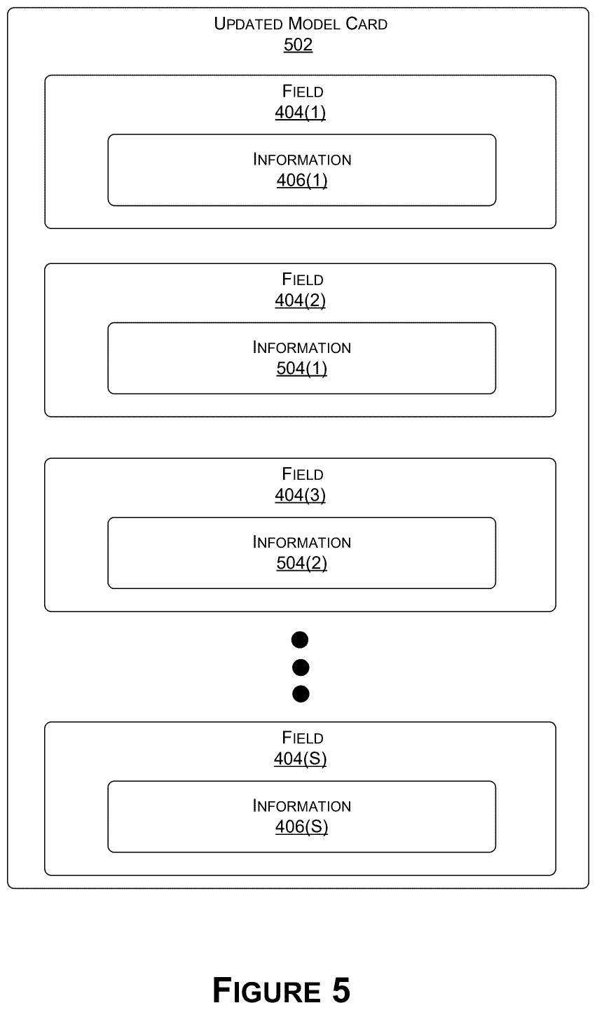

For instance, FIG. 5 illustrates an example of updating the model card 402 associated with the model from the example of FIG. 4, in accordance with some embodiments of the present disclosure. In the example of FIG. 5, one or more updates may have occurred to the model, such as the name of the model being updated, the model being further trained using an updated dataset, the model being further trained to perform one or more new tasks, and/or any other update. As such, by performing at least a portion of the process 150, an updated model card 502 may be generated that includes updating at least the information 406(2) associated with the second field 404(2) of the model card 402 to include new information 504(1) and the information 406(3) associated with the third field 404(3) of the model card 402 to include new information 502(2). This way, instead of requiring one or more users to provide inputs to update the model card 402, the process 150 may automatically generate the updated model card 502 using the updated information 504(1)-(2).

Referring back to the example of FIG. 1B, in some examples, at least a portion of the data associated with the process 150 may differ as compared to the data associated with the process 100 in order to update the previously generated model card instead of generating a new model card. For instance, the request data 124 may represent additional and/or alternative queries that are specific to the updating of the model card. For example, if only one or more specific fields of the model card need to be updated based on one or more updates to the model 106, then the request data 124 may represent one or more queries associated with the specific field(s) without including additional queries associated with the model 106. This way, the chunks data 126 that is retrieved using the request data 124 may represent chunks of information and/or embeddings associated with the chunks of information that are relevant to the specific field(s) of the model card being updated.

Additionally, since the language model(s) 130 is being used to update the previously generated model card rather than to generate a new model card, the prompt data 128 may represent a different prompt that is specific to updating model cards. For example, the prompt data 128 may represent a prompt that causes the language model(s) 130 to update the previously generated model card and/or update one or more specific fields of the previously generated model card.

As further described herein, in some examples, it may be important to verify that the model card associated with the model 106 is accurate since the model card may be used to evaluate the model 106. For a first example, one or more users may use the model card to determine whether the model 106 is capable of performing one or more tasks and/or determine capabilities of a computing device that are needed to execute the model 106. For a second example, one or more systems may use the model card to determine whether to provide the model 106 to one or more computing devices and/or one or more users for execution. As such, FIG. 1C illustrates an example of a process 156 for verifying a model card associated with a model, in accordance with some embodiments of the present disclosure.

As shown, the process 156 may be similar to the process 150 except, in the example of FIG. 1C, language model(s) 130 is used to verify the model card represented by the card data 152 rather than update the model card. For instance, the process 156 may again include the language model(s) 130 processing at least the output data 134, the chunks data 146, and the card data 152, such as during the second processing task associated with the second call 132(2). In some examples, the language model(s) 130 may perform any type of processing, such as the processing described herein with respect to FIGS. 11A-11C. Based at least on the processing, the process 156 may include the language model(s) 130 generating and/or outputting verification data 158. As described herein, the verification data 158 may represent whether the model card is verified (e.g., a verification flag), such as when the information included in the model card is accurate, or whether the model card is not verified (e.g., a non-verification flag), such as when at least a portion of the information included in the model card is inaccurate.

In some examples, such as when the model card is not verified, the verification data 158 may represent additional information associated with verifying the model card. For instance, the verification data 158 may represent one or more indications of one or more fields from the model card for which the information is inaccurate, the information from the model card that is inaccurate, and/or updated information that should be included in the model card to make the model card accurate. For a first example, if a field of the model card that is associated with a name of the model 106 is inaccurate, then the verification data 158 may represent an indication that the field is inaccurate, the current name included in the model card that is inaccurate, and/or the correct name that should be included in the model card. For a second example, if a field of the model card that is associated with a computing requirement for executing the model 106 is inaccurate, then the verification data 158 may represent an indication of the field that is inaccurate, the current computing requirement included in the model card that is inaccurate, and/or the correct computing requirement that should be included in the model card.

Similar to the example of FIG. 1B, in some examples, at least a portion of the data associated with the process 156 may differ as compared to the data associated with the process 150 in order to verify the model card instead of updating the model card. For instance, since the language model(s) 130 is being used to verify the model card rather than to update the model card, the prompt data 128 may represent a different prompt that is specific to verifying model cards. For example, the prompt data 128 may represent a prompt that causes the language model(s) 130 to verify the model card, verify one or more specific portions of the model card, and/or generate the verification data 158 that is associated with verifying the model card.

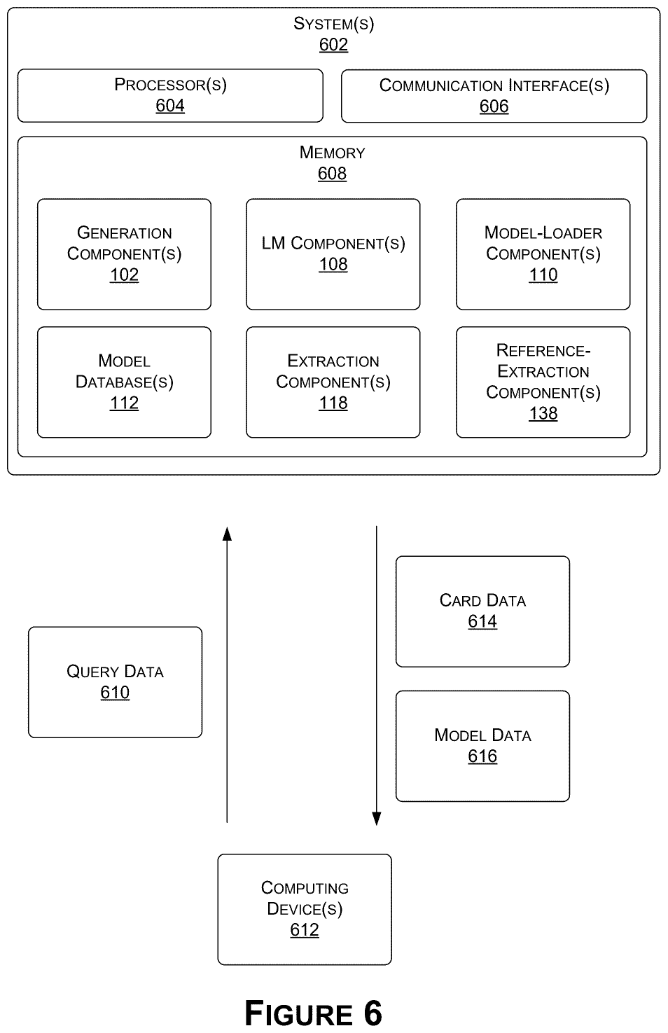

As described herein, in some examples, the model card associated with the model 106 may be used to perform one or more additional tasks. For instance, FIG. 6 illustrates an example of one or more systems 602 that may use model cards to perform various tasks, in accordance with some embodiments of the present disclosure. As shown, the system(s) 602 (which may represent, and/or be similar to, an example computing device 1200 and/or an example data center 1300) may include at least one or more processors 604 (which may represent, and/or be similar to, one or more central processing units 1206 and/or one or more graphics processing units 1208), one or more communication interfaces 606 (which may be represent, and/or be similar to, one or more communication interfaces 1210), and memory 608 (which may represent, and/or be similar to, memory 1204). However, in other examples, the system(s) 602 may include additional components.

As shown, the system(s) 602 may store, in the memory 608, the generation component(s) 102, the LM component(s) 108, the model-loader component(s) 110, the model database(s) 112, the extraction component(s) 118, and/or the reference-extraction component(s) 138. Additionally, the system(s) may use the processor(s) 604 to execute the generation component(s) 102, the LM component(s) 108, the model-loader component(s) 110, the model database(s) 112, the extraction component(s) 118, and/or the reference-extraction component(s) 138 in order to perform at least a portion of the process 100 of FIG. 1A, at least a portion of the process 150 of FIG. 1B, and/or at least a portion of the process 156 of FIG. 1C. For example, the system(s) 602 may be configured to automatically generate model cards, update model cards, and/or verify model cards.

In some examples, the system(s) 602 may further be configured to perform one or more tasks using the model cards. For instance, the system(s) 602 may receive query data 610 representing one or more queries from one or more computing devices 612 (e.g., one or more endpoints). In some examples, a query may be associated with a computing device(s) 612 seeking information included in the model card associated with a model, such as training details, risk scores, bias details, hardware specifications for optimal performance, and/or the like. As such, based on receiving such a query, the system(s) may obtain the model card from the model database(s) 112 and send card data 614 representing the model card to the computing device(s) 612.

Additionally, or alternatively, in some examples, the system(s) 602 may also enforce execution of the model(s) based at least on criteria checked against the model card(s). In this way, the system(s) 602 may prevent the model(s) from executing in scenarios that would be, for instance, non-compliant within the constraints of an enterprise, not optimized for the execution environment, and/or the like. The enforcement of model execution at runtime may enable users and/or organizations to restrict the model(s) from executing based at least on factors like license, training data, risk assessment, bias, and/or the like.

For example, a query received from a computing device(s) 612 may include a request to execute one or more particular models. As such, the system(s) 602 may obtain at least the model card(s) stored in association with that particular model(s) and evaluate the model card(s) with respect to one or more criteria associated with the computing device(s) 612. In some examples, the criteria may include a policy associated with the computing device(s) 612 (e.g., an enterprise policy, device policy, group policy, etc.) that indicates various requirements, expectations, limitations, etc. associated with the model(s) that is allowed to be used in compliance with the policy. As an example, the policy may indicate, among other things, risk thresholds for models, license requirements for models, training requirements for models, etc. Additionally, or alternatively, the criteria may include hardware specifications indicating one or more limitations and/or capabilities associated with the computing device(s) 612 that is to execute the model(s). For instance, the hardware specification may indicate features (e.g., type of processor, make of processor, model of processor, etc.) associated with one or more processors of the computing device(s) 612, memory limitations and/or capabilities associated with the computing device(s) 612, version numbers associated with the computing device(s) 612, etc.

Based at least on the evaluating, the system(s) 602 may determine that the computing device(s) 612 is allowed and/or capable of executing the particular model(s) requested. For instance, the system(s) 602 may determine that the particular model(s) is in compliance with a given set of requirements (e.g., which may be indicated in the policy), that the particular model(s) is optimized for the execution environment of the computing device(s) 612, and/or that the hardware of the computing device(s) 612 is able to properly execute the particular model(s). The system(s) 602 may then cause model data 616 to be sent to the computing device(s) 612 for executing the particular model(s) on the computing device(s) 612.

However, if the system(s) determines that the computing device(s) 612 is prevented from executing the particular model(s), the system(s) 602 may send an indication to the computing device(s) 612. In some examples, the indication may indicate one or more reasons why the particular model(s) is prevented from executing on the computing device(s) 612. For example, the indication may indicate that the policy restricts the computing device(s) 612 from executing the particular model(s) and/or that the capabilities/limitations of the computing device(s) 612 may prevent the particular model(s) from being executed.

In some examples, and as described herein, the model card(s) may indicate a risk score(s) associated with the particular model(s), and the system(s) 602 may evaluate the risk score(s) with respect to a threshold risk score associated with the computing device(s) 612 (e.g., indicated in the policy). Based at least on the evaluation, the system(s) 602 may determine whether or not to provide the model data 616 to the computing device(s) 612 for executing the particular model(s). That is, if the risk score(s) for the particular model(s) meets or exceeds the risk threshold, the system(s) 602 may determine to preclude the particular model(s) from execution on the computing device(s) 612, but if the risk score is less than the risk threshold, the system(s) 602 may determine to allow the particular model(s) to be executed by the computing device(s) 612.

As another example, the system(s) 602 may determine, based at least on the model card(s), one or more hardware thresholds corresponding to one or more hardware capabilities for executing the particular model(s). The system(s) 602 may then evaluate actual capabilities associated with the computing device(s) 612 with respect to the hardware threshold(s) to determine whether or not to provide the model data 616 to the computing device(s) 612 for executing the particular model(s). If the system(s) 602 determines the actual capabilities meet or exceed the hardware threshold(s), the system(s) 602 may determine to provide the particular model(s) to the computing device(s) 612, but if the actual capabilities do not meet the hardware threshold(s), the system(s) 602 may determine to prevent the particular model(s) from being executed by the computing device(s) 612.

In some examples, the system(s) 602 may propose one or more alternative (e.g., better suited, more capable, etc.) model(s) to the computing device(s) 612. In some examples, the alternative model(s) may be proposed to the computing device(s) 612 based at least on determining that the computing device(s) 612 is prevented from executing the particular model(s). Additionally, or alternatively, the computing device(s) 612 may query the system(s) 602 for a model(s) that meets certain criteria, prerequisites, intended purposes, etc. By way of example, and not limitation, the computing device(s) 612 may request a model for detecting objects in an environment of a machine, that has been trained using a closed source (e.g., non-open source) dataset, and that is optimized for rural environments. Based on this request, the system(s) 602 may evaluate the model card(s) for various potential model(s) that would meet these requirements.

While the examples herein illustrate the generation component(s) 102, the LM component(s) 108, the model-loader component(s) 110, the extraction component(s) 118, and the reference-extraction component(s) 138 as including separate components, in other examples, one or more of the generation component(s) 102, the LM component(s) 108, the model-loader component(s) 110, the extraction component(s) 118, and the reference-extraction component(s) 138 may be combined. Additionally, a component may include, but is not limited to, a system, a server, a computing device, hardware, software, a machine learning model, a neural network, a transformer, an encoder, a module, and/or any other type of processing component that is configured to perform at least a portion of the processes described herein.

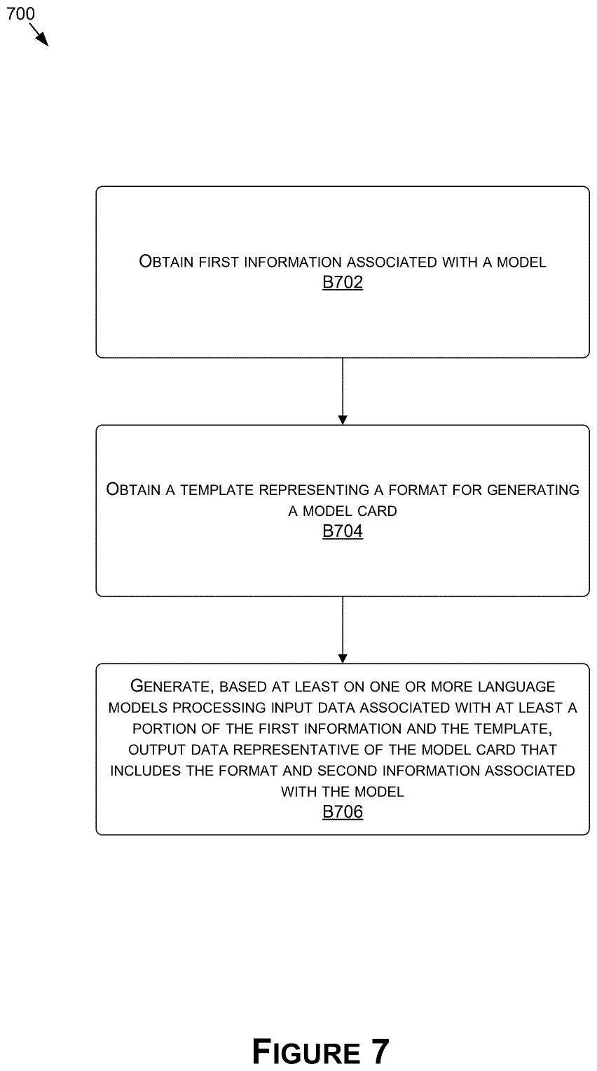

Now referring to FIG. 7-10, each block of methods 700, 800, 900, and 1000, described herein, comprises a computing process that may be performed using any combination of hardware, firmware, and/or software. For instance, various functions may be carried out by a processor executing instructions stored in memory. The methods 700, 800, 900, and 1000 may also be embodied as computer-usable instructions stored on computer storage media. The methods 700, 800, 900, and 1000 may be provided by a standalone application, a service or hosted service (standalone or in combination with another hosted service), or a plug-in to another product, to name a few. In addition, these methods 700, 800, 900, and 1000 are described, by way of example, with respect to FIGA. 1A-1C and 6. However, these methods 700, 800, 900, and 1000 may additionally or alternatively be executed by any one system, or any combination of systems, including, but not limited to, those described herein.

FIG. 7 illustrates a flow diagram showing a method 700 for generating a new model card associated with a model, in accordance with some embodiments of the present disclosure. The method 700, at block B702, may include obtaining first information associated with a model. For instance, the model-loader component(s) 110 may retrieve the first information from the model database(s) 112, such as the source code 114 and/or the document(s) 116 associated with the model 106. In some examples, the model-loader component(s) 110 may then use the extraction component(s) 118 to extract at least a portion of the first information that is relevant for generating the model card associated with the model 106. For instance, the model-loader component(s) 110 may use the extraction component(s) 118 to extract at least a portion of the first information that is associated with one or more queries related to generating the model card.

The method 700, at block B704, may include obtaining a template representing a format for generating a model card. For instance, the model-loader component(s) 110 may obtain the template data 136 representing the model card template. As described herein, the model card template may represent the fields to include in the model card and/or the layout for the fields within the model card. In some examples, the model card template may be general for all model cards while, in other examples, the model card template may be specific to a type of the model card and/or a type of the model 106.

The method 700, at block B706, may include generating, based at least on one or more language models processing input data associated with at least a portion of the first information and the template, output data representative of the model card that includes the format and second information associated with the model. For instance, the language model(s) 130 may process the input data associated with the at least the portion of the first information and the template. In some examples, the input data to the language model(s) 130 may represent text associated with the at least the portion of the first information and the template while, in some examples, the input data may represent one or more embeddings associated with the at least the portion of the first information and the template. The language model(s) 130 may then generate the card data 148 representing the model card that includes the format and the second information associated with the model 106.

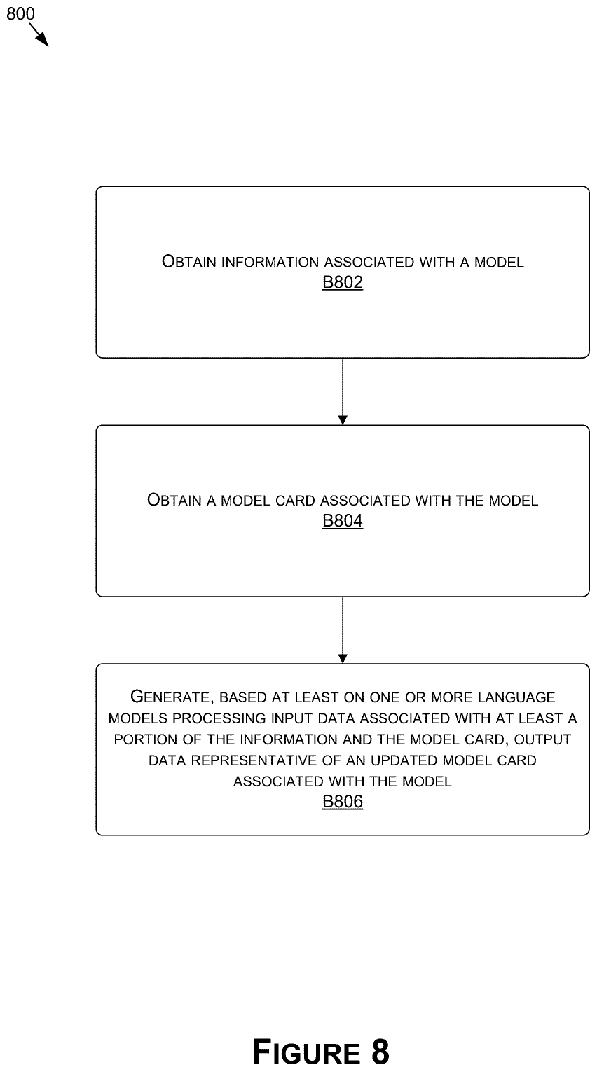

FIG. 8 illustrates a flow diagram showing a method 800 for updating a model card associated with a model, in accordance with some embodiments of the present disclosure. The method 800, at block B802, may include obtaining information associated with a model. For instance, the model-loader component(s) 110 may retrieve the information from the model database(s) 112, such as the source code 114 and/or the document(s) 116 associated with the model 106. In some examples, the model-loader component(s) 110 may then use the extraction component(s) 118 to extract at least a portion of the information that is relevant for updating the model card associated with the model 106. For instance, the model-loader component(s) 110 may use the extraction component(s) 118 to extract at least a portion of the information that is associated with one or more queries related to updating the model card.

The method 800, at block B804, may include obtaining a model card associated with the model. For instance, the model-loader component(s) 110 may obtain the card data 152 representing the model card associated with the model 106. As described herein, in some examples, the model card may be associated with a previous version of the model 106. For example, after generating the model card, one or more updates may have occurred to the model 106, such as the model 106 being further trained using a new dataset. As such, the model card may no longer represent accurate information associated with the model 106 as updated.

The method 800, at block B806, may include generating, based at least on one or more language models processing input data associated with at least a portion of the information and the model card, output data representative of an updated model card associated with the model. For instance, the language model(s) 130 may process the input data associated with the at least the portion of the information and the model card. In some examples, the input data to the language model(s) 130 may represent text associated with the at least the portion of the information and the model card while, in some examples, the input data may represent one or more embeddings associated with the at least the portion of the information and the model card. The language model(s) 130 may then generate the updated card data 154 representing the updated model card associated with the model 106. For example, the updated model card may include new information representing one or more updates associated with the model 106.

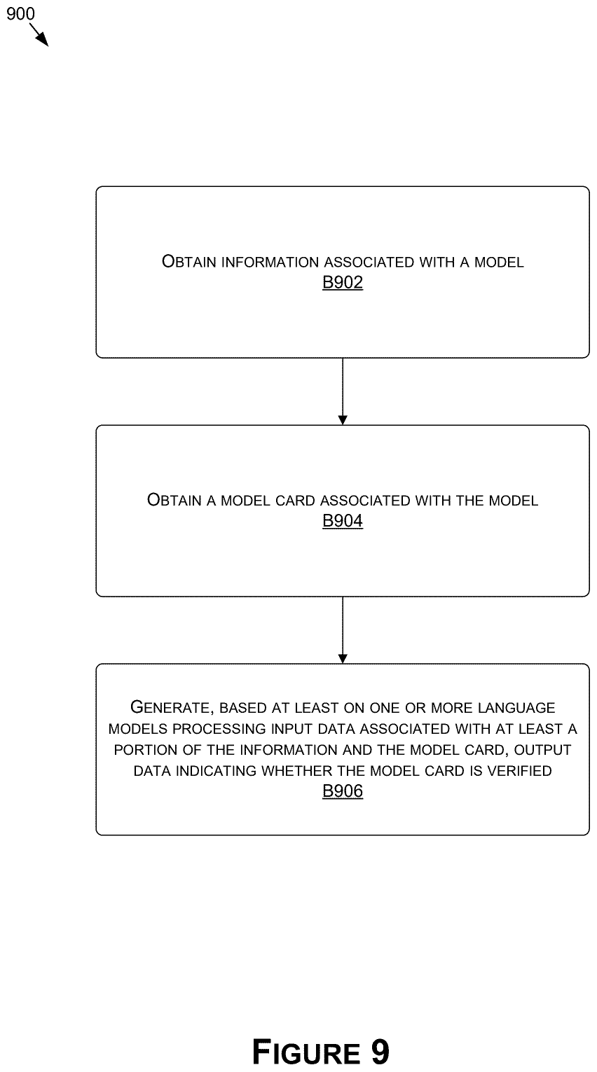

FIG. 9 illustrates a flow diagram showing a method 900 for verifying a model card associated with a model, in accordance with some embodiments of the present disclosure. The method 900, at block B902, may include obtaining information associated with a model. For instance, the model-loader component(s) 110 may retrieve the information from the model database(s) 112, such as the source code 114 and/or the document(s) 116 associated with the model 106. In some examples, the model-loader component(s) 110 may then use the extraction component(s) 118 to extract at least a portion of the information that is relevant for updating the model card associated with the model 106. For instance, the model-loader component(s) 110 may use the extraction component(s) 118 to extract at least a portion of the information that is associated with one or more queries related to verifying the model card.

The method 900, at block B904, may include obtaining a model card associated with the model. For instance, the model-loader component(s) 110 may obtain the card data 152 representing the model card associated with the model 106. As described herein, in some examples, the model card may be associated with a current version of the model 106. For example, the model card may need to represent current information associated with the model 106.

The method 900, at block B906, may include generating, based at least on one or more language models processing input data associated with at least a portion of the information and the model card, output data indicating whether the model card is verified. For instance, the language model(s) 130 may process the input data associated with the at least the portion of the information and the model card. In some examples, the input data to the language model(s) 130 may represent text associated with the at least the portion of the information and the model card while, in some examples, the input data may represent one or more embeddings associated with the at least the portion of the information and the model card. The language model(s) 130 may then generate the verification data 158 indicating whether the model card is verified. As described herein, such as if the model card is not verified, the verification data 158 may further represent one or more indications of one or more fields from the model card for which the information is inaccurate, the information from the model card that is inaccurate, and/or updated information that should be included in the model card to make the model card accurate.

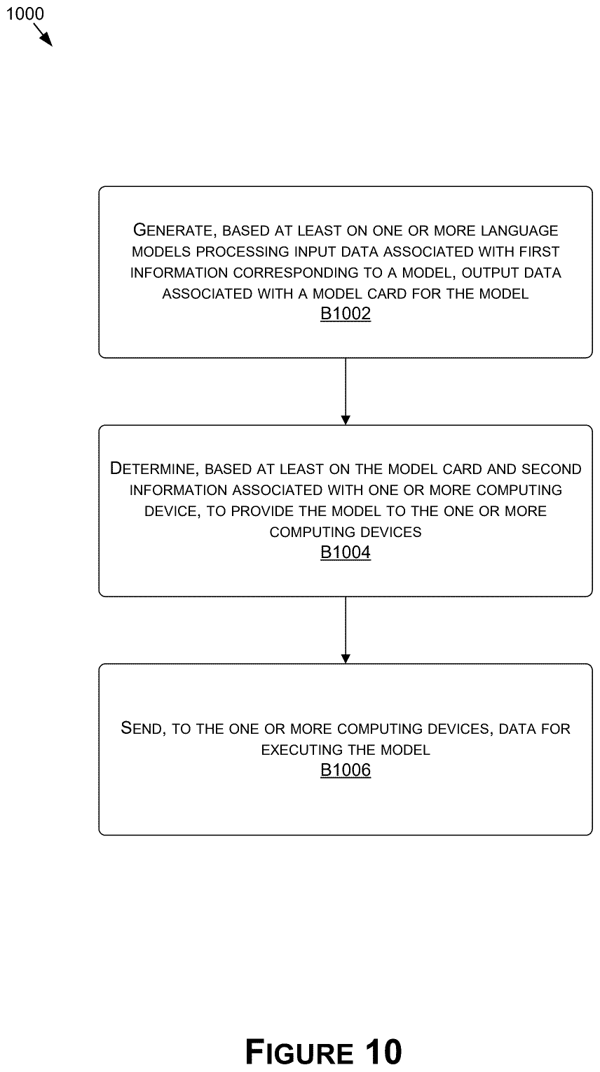

FIG. 10 illustrates a flow diagram showing a method 1000 for generating a model card that is then used to determine whether to provide a model to one or more computing devices, in accordance with some embodiments of the present disclosure. The method 1000, at block B1002, may include generating, based at least on one or more language models processing input data associated with first information corresponding to a model, output data associated with a model card for the model. For instance, the language model(s) 130 may process the input data associated with the first information, such as information representing the source code 114, the document(s) 116, and/or a previous model card for the model 106. Based at least on the processing, the language model(s) 130 may generate the output data associated with the model card, such as the card data 148 representing a new model card or the updated card data 154 representing an updated model card.

The method 1000, at block B1004, may include determining, based at least on the model card and second information associated with one or more computing devices, to provide the model card to the one or more computing devices. For instance, the system(s) 602 may receive a query that includes the second information, such as one or more capabilities associated with the computing device(s) 612 and/or one or more criteria for executing the model 106 on the computing device(s) 612. The system(s) 602 may then determine to provide the model 106 to the computing device(s) 602 based at least on comparing the model card to the second information, using one or more of the techniques described herein.

The method 1000, at block B1006, may include sending, to the one or more computing device, data for executing the model. For instance, the system(s) 602 may send to card data 614 to the computing device(s) 612, where the card data 614 allows the computing device(s) 612 to execute the model 106.

### EXAMPLE LANGUAGE MODELS

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases) - such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, and/or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. One or more generative processing pipelines that include LLMs may also include one or more diffusion block(s) (e.g., denoisers). The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. Ser. No. 18/304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated —e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources - such as APIs, plug-ins, and/or the like.

In some embodiments, multiple language models (e.g., LLMs/VLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language mode—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1130. In some embodiments, the input 1101 includes plain text in the form of one or more sentences, paragraphs, code snippets, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multimodal inputs, the input 1101 may combine text with image data, audio data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 may be used to retrieve additional information to be used as part of the input 1101 or prompt. For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The tokenizer 1110 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data, the input processor 1101 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LM 1130 and/or other components of the generative LLM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example implementation in which the generative LM 1130 includes a transformer encoder-decoder. For example, assume input text such as “Who discovered gravity” is tokenized (e.g., by the tokenizer1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example implementation, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

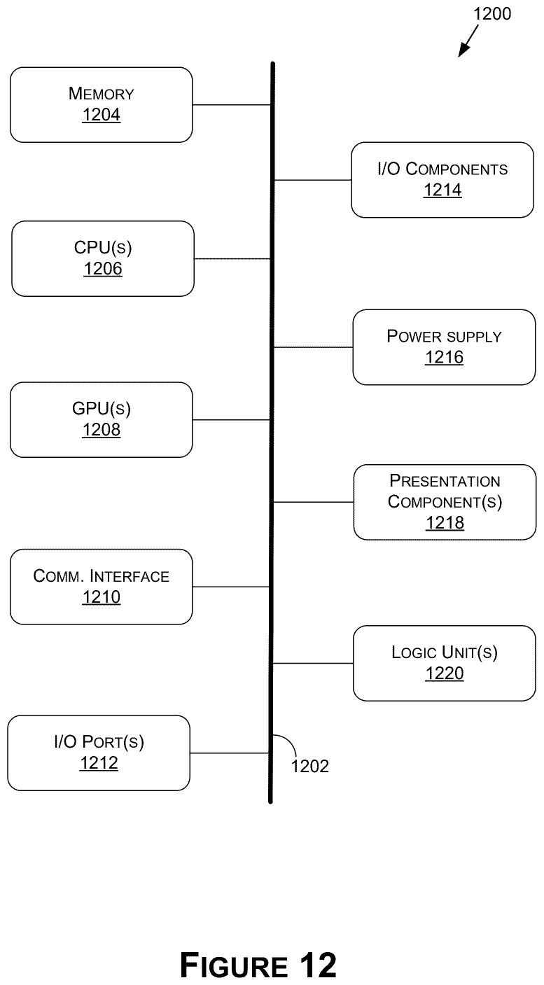

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### EXAMPLE DATA CENTER

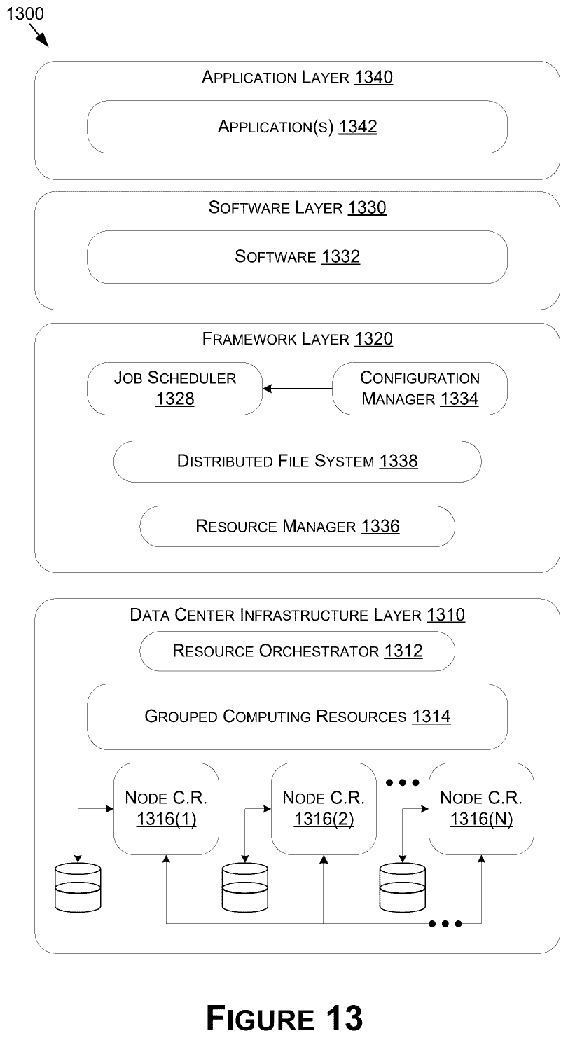

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark^{TM} (hereinafter “Spark”) that may utilize distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: generating, based at least on one or more language models processing input data representative of first information associated with a machine learning model, output data representative of a model card that includes second information describing the machine learning model; determining, based at least on the model card or template and one or more capabilities associated with one or more computing devices, to provide the machine learning model to the one or more computing devices; and sending, to the one or more computing devices, data for executing the machine learning model.

B: The method of paragraph A, further comprising: obtaining one or more queries associated with one or more fields included in the model card; and extracting, based at least on the one or more queries, the first information from at least one of source code associated with the machine learning model, one or more documents describing the machine learning model, or a second model card associated with the machine learning model.

C: The method of either paragraph A or paragraph B further comprising: obtaining a template that includes a format for generating the model card, wherein: the generating the model card is further based at least on the one or more language models processing second input data representative of the template; and the model card includes the second information arranged according to the format from the template.

D: The method of any one of paragraphs A-C, further comprising: obtaining a second model card associated with the machine learning model, the second model card including third information describing the machine learning model, wherein: the generating the model card is further based at least on the one or more language models processing second input data representative of the second model card; and at least a portion of the second information included in the model card includes updated information as compared to the third information included in the second model card.

E: The method of any one of paragraphs A-D, wherein the generating the model card comprises: generating, based at least on the one or more language models processing the input data, initial output data; and generating, based at least on the one or more language models processing the initial output data and second input data representative of at least one of a template associated with the model card or a second model card associated with the machine learning model, the output data representative of the model card.

F: The method of any one of paragraphs A-E, further comprising: obtaining third information associated with one or more second machine learning models, wherein the generating the model card is further based at least on the one or more language models processing second input data representative of the third information.

G: The method of paragraph F, wherein the obtaining the second information comprises extracting, based at least on the first information, the second information from at least one of source code associated with the one or more second machine learning models, one or more documents associated with the one or more second machine learning models, or one or more model cards associated with the one or more second machine learning models.

H: The method of any one of any one of paragraphs A-G further comprising: retrieving, from one or more database, one or more embedding associated with the first information, wherein the input data representative of the first information includes at least the one or more embeddings.

I: The method of any one of paragraphs A-H, wherein the second information includes at least one of: an identifier associated with the machine learning model; one or more identifiers of one or more datasets used to train the machine learning model; one or more sizes of the one or more datasets; one or more license types associated with the machine learning model; one or more risk scores associated with the machine learning model; one or more bias scores associated with the machine learning model; one or more inputs to the machine learning model; one or more outputs from the machine learning models; one or more expected users associated with the machine learning model; or one or more computing requirements associated with executing the machine learning model.

J: A system comprising: one or more processors to: obtain, from one or more databases, first information corresponding to a machine learning model; generate, based at least on one or more language models processing input data associated with the first information, output data representative of a model card that includes second information describing the machine learning model; and perform, based at least on the model card, one or more operations associated with the machine learning model.

K: The system of paragraph J, wherein the first information is obtained at least by: obtaining one or more queries associated with one or more fields included in the model card; generating one or more first embeddings associated with the one or more queries; and retrieving, from the one or more databases, one or more second embeddings that are related to the one or more first embeddings, the one or more second embedding being associated with the first information.

L: The system of either paragraph J or paragraph K, wherein the one or more processors are further to: obtain a template that includes a format for generating the model card, wherein: the model card is further generated based at least on the one or more language models processing second input data representative of the template; and the model card includes the second information arranged according to the format from the template.

M: The system of any one of paragraphs J-L, wherein the one or more processors are further to: obtain a second model card associated with the machine learning model, the second model card including third information describing the machine learning model, wherein: the model card is further generated based at least on the one or more language models processing second input data representative of the second model card; and at least a portion of the second information included in the model card includes updated information as compared to the third information included in the second model card.

N: The system of any one of paragraphs J-M, wherein the generation of the model card comprises: generating, based at least on the one or more language models processing the input data, initial output data; obtaining second input data representative of at least one of a template associated with the model card or a second model card associated with the machine learning model; and generating, based at least on the one or more language models processing the initial output data and the second input data, the output data representative of the model card.

O: The system of any one of paragraphs J-N, wherein the one or more processors are further to: obtain third information associated with one or more second machine learning models, wherein the model card is further generated based at least on the one or more language models processing second input data associated with the second information.

P: The system of paragraph O, wherein the second information is obtained at least by extracting, based at least on the first information, the second information from at least one of source code associated with the one or more second machine learning models, one or more documents associated with the one or more second machine learning models, or one or more model cards associated with the one or more second machine learning models.

Q: The system of any one of paragraphs J-P, wherein the performance of the one or more operations comprises at least one of: storing the model card in association with the machine learning model; or determining, based at least on at least one of one or more policies or one or more capabilities associated with one or more computing devices and the model card, whether to provide the model card to the one or more computing devices.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to: generate one or more embeddings associated with information describing a machine learning model; generate, based at least on one or more language models processing input data associated with the one or more embeddings, output data representative of a model card that includes at least a portion of the information describing the machine learning model; and store the model card in association with the machine learning model.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
generating, based at least on one or more language models processing input data representative of first information associated with a machine learning model, output data representative of a model card that includes second information describing the machine learning model;
determining, based at least on the model card or template and one or more capabilities associated with one or more computing devices, to provide the machine learning model to the one or more computing devices; and
sending, to the one or more computing devices, data for executing the machine learning model.

2. The method of claim 1, further comprising:
obtaining one or more queries associated with one or more fields included in the model card; and
extracting, based at least on the one or more queries, the first information from at least one of source code associated with the machine learning model, one or more documents describing the machine learning model, or a second model card associated with the machine learning model.

3. The method of claim 1, further comprising:
obtaining a template that includes a format for generating the model card, wherein:
the generating the model card is further based at least on the one or more language models processing second input data representative of the template; and
the model card includes the second information arranged according to the format from the template.

4. The method of claim 1, further comprising:
obtaining a second model card associated with the machine learning model, the second model card including third information describing the machine learning model,
wherein:
the generating the model card is further based at least on the one or more language models processing second input data representative of the second model card; and
at least a portion of the second information included in the model card includes updated information as compared to the third information included in the second model card.

5. The method of claim 1, wherein the generating the model card comprises:
generating, based at least on the one or more language models processing the input data, initial output data; and
generating, based at least on the one or more language models processing the initial output data and second input data representative of at least one of a template associated with the model card or a second model card associated with the machine learning model, the output data representative of the model card.

6. The method of claim 1, further comprising:
obtaining third information associated with one or more second machine learning models,
wherein the generating the model card is further based at least on the one or more language models processing second input data representative of the third information.

7. The method of claim 6, wherein the obtaining the second information comprises extracting, based at least on the first information, the second information from at least one of source code associated with the one or more second machine learning models, one or more documents associated with the one or more second machine learning models, or one or more model cards associated with the one or more second machine learning models.

8. The method of claim 1, further comprising:
retrieving, from one or more database, one or more embedding associated with the first information,
wherein the input data representative of the first information includes at least the one or more embeddings.

9. The method of claim 1, wherein the second information includes at least one of:
an identifier associated with the machine learning model;
one or more identifiers of one or more datasets used to train the machine learning model;
one or more sizes of the one or more datasets;
one or more license types associated with the machine learning model;
one or more risk scores associated with the machine learning model;
one or more bias scores associated with the machine learning model;
one or more inputs to the machine learning model;
one or more outputs from the machine learning models;
one or more expected users associated with the machine learning model; or
one or more computing requirements associated with executing the machine learning model.

10. A system comprising:
one or more processors to:
obtain, from one or more databases, first information corresponding to a machine learning model;
generate, based at least on one or more language models processing input data associated with the first information, output data representative of a model card that includes second information describing the machine learning model; and
perform, based at least on the model card, one or more operations associated with the machine learning model.

11. The system of claim 10, wherein the first information is obtained at least by:
obtaining one or more queries associated with one or more fields included in the model card;
generating one or more first embeddings associated with the one or more queries; and
retrieving, from the one or more databases, one or more second embeddings that are related to the one or more first embeddings, the one or more second embedding being associated with the first information.

12. The system of claim 10, wherein the one or more processors are further to:
obtain a template that includes a format for generating the model card, wherein:
the model card is further generated based at least on the one or more language models processing second input data representative of the template; and
the model card includes the second information arranged according to the format from the template.

13. The system of claim 10, wherein the one or more processors are further to:
obtain a second model card associated with the machine learning model, the second model card including third information describing the machine learning model,
wherein:
the model card is further generated based at least on the one or more language models processing second input data representative of the second model card; and
at least a portion of the second information included in the model card includes updated information as compared to the third information included in the second model card.

14. The system of claim 10, wherein the generation of the model card comprises:
generating, based at least on the one or more language models processing the input data, initial output data;
obtaining second input data representative of at least one of a template associated with the model card or a second model card associated with the machine learning model;
and generating, based at least on the one or more language models processing the initial output data and the second input data, the output data representative of the model card.

15. The system of claim 10, wherein the one or more processors are further to:
obtain third information associated with one or more second machine learning models,
wherein the model card is further generated based at least on the one or more language models processing second input data associated with the second information.

16. The system of claim 15, wherein the second information is obtained at least by extracting, based at least on the first information, the second information from at least one of source code associated with the one or more second machine learning models, one or more documents associated with the one or more second machine learning models, or one or more model cards associated with the one or more second machine learning models.

17. The system of claim 10, wherein the performance of the one or more operations comprises at least one of:
storing the model card in association with the machine learning model; or
determining, based at least on at least one of one or more policies or one or more capabilities associated with one or more computing devices and the model card, whether to provide the model card to the one or more computing devices.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to:
generate one or more embeddings associated with information describing a machine learning model;
generate, based at least on one or more language models processing input data associated with the one or more embeddings, output data representative of a model card that includes at least a portion of the information describing the machine learning model; and
store the model card in association with the machine learning model.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
